(19) United States
(12) Patent Application Publication
(10) Pub. No.: US 2012/0113039 A1
(43) Pub. Date: May 10, 2012

(54) MULTILAYER AND MULTIPLEXING TOUCH SENSING DEVICE

(76) Inventor: Loi Nghiem, Riverside, CA (US)

(21) Appl. No.: 13/349,516

(22) Filed: Jan. 12, 2012

Related U.S. Application Data
(63) Continuation-in-part of application No. 13/374,564, filed on May 13, 2010.

(51) Int. Cl. G06F 3/041

(52) U.S. Cl. 345/173

(57) ABSTRACT

A multiple layer touch sensing device for the multiplexing of signal lines. The input device includes an electrode layer for providing a plurality of touch keys having one or more electrodes associated with each touch key. A first signal layer is connected to the electrode layer and has a plurality of signal traces connected to certain of the electrodes. A second signal layer is connected to the first signal layer and has a plurality of signal traces connected to different electrodes. When a user touches a touch key, signals are passed along the signal traces connected to the electrodes of that touch key. The number of output signals may thus be fewer than the total number of touch keys. Any number of signal layers may be utilized and/or any number of signal traces may be disposed upon each layer to achieve a desired number of touch keys and/or output signals.

### CROSS REFERENCE TO RELATED APPLICATIONS

This application is a continuation-in-part application of U.S. patent application Ser. No. 13/374,564, filed on May 13, 2010, the entire contents of which is incorporated herein by reference.

### BACKGROUND

1. Field

The present invention relates generally to improvements in touch sensing devices and more particularly pertains to multiplexing of signal lines in touch sensing input devices.

2. Description of the Related Art

As electronic devices and equipment become increasingly utilized in both the commercial and industrial sectors, manners and methods of controlling or interfacing with such devices and equipment becomes of particular importance. Modern electronic or computer systems commonly require some form of user interaction for proper operation. Even in substantially mechanical systems, a processor or other form of controller is commonly employed for interfacing with a user. The user usually controls the functionality of the system, provides data input to the system, or otherwise ensures that the system operates as intended. Moreover, since modern desktop or notebook computers, wireless laptops, touchpads, and mobile phones have become commonplace across society, allowing users the capability to interface with such computers or devices through an input device is an essential feature.

Currently, mechanical keyboards or input panels provide the typical interfacing means between the users and a computer system. The user input can be as simple as sending a desired alphanumerical symbol, for example, when involved in word processing. Alternatively, the user input may be more complex and include rotating a knob or dial on the keyboard to perform a function of the operating system, such as controlling a volume of an audio source being provided to a connected set of speakers. Home desktop computers typically utilize mechanical keyboards composed of a variety of mechanical buttons or keys for these functions. When a user presses down upon a mechanical key, a spring associated with the key is compressed and a conductive contact coupled with the key makes an electrical connection with a second conductive contact. This electrical connection establishes a signal path for the associated mechanical key to a connected processor, effectively notifying the computer system when the key has been pressed by the user. When the user subsequently releases their finger from the mechanical key, the compressed spring expands to its at-rest configuration and the mechanical key travels upward, effectively disconnecting the electrical connection between the two contacts. While an effective method for allowing user input with the computer system, mechanical keyboards or input panels are a host to a number of disadvantages.

Since a mechanical input device relies upon buttons, knobs, switches, dials, or other forms of mechanical components that must be manipulated by a user, such devices inherently run an increased risk of component failure since these mechanical elements all have a particular life expectancy. The more often a physical button is pressed or a knob is rotated, the quicker the mechanical component will fail due to frictional, spring-based, or other forces repeatedly acting upon the components. Environmental conditions such as humidity or heat can also decrease the reliability or life span of these mechanical components. Mechanical input devices also can be undesirably heavy for certain applications, particularly in large devices with a significant number of mechanical components. In addition, the cost of mechanical input devices can be high given the quantity of component parts that must be manufactured and connected or assembled together to form the input device. Sheet metal and the requisite drilling of holes or openings for engaging with the mechanical components can similarly add to the cost. Oftentimes, such manufacturing is not environmentally friendly since the production or manipulation of a large quantity of plastic or other components results in dust or other wasteful manufacturing byproducts.

Significantly, given the construction limits of mechanical input devices, multiplexing of input key electrical signals for output to a processor has only been practical in, at most, two dimensions. Such a limitation can significantly affect the cost of the input device, and any computer system connected to it, since a processor with ever increasing numbers of input pins must be used to accommodate increasing numbers of keys on the input device. For example, in a single dimension input device with one hundred input keys, a connected processor with at least one hundred input pins must be used in order to interface with the device. In another example, a two dimension input device with one hundred input keys would require a connected processor with at least twenty input pins in order to properly interface with the device. As can be seen, this number quickly becomes unwieldy for systems with large numbers of user inputs and can make the processor required prohibitively expensive for many applications.

Touch-based input devices, such as touch screens, touch panels, or other forms of electronic keypads, have been used in an effort to alleviate some of the above problems associated with mechanical input devices. By utilizing such devices in place of mechanical components, the issues of reliability, durability, weight, and environmental friendliness may be addressed. However, cost is still a significant issue for touch-based input devices because current touch-based input devices operate only with single dimension functionality, thus requiring processors with a 1:1 ratio of input pins to device keys. As previously stated, such a configuration can prove very costly and unmanageable as input keys grow in number. For example, on standard desktop computer keyboards where greater than one hundred input keys are commonly needed, replacing the mechanical keyboard with a current one dimension touch-based input device would necessitate a processor with over one hundred input pins available only for interfacing with the touch-based input device. Since the processor must commonly also use additional pins to interface with inputs/outputs other than the keyboard input, it is apparent why current touch-based devices have failed to replace mechanical input devices for a large proportion of computer systems.

Thus, a touch-based input device or method is needed that is low cost, easy to manufacture, and capable of reducing the number of pins needed on a connected processor. Moreover, the touch-based input device must be capable of accurately interfacing with a human finger that is often many times larger than electrodes that may be manufactured for the touch-based input device.

### SUMMARY

A touch sensing device is disclosed capable of multiplexing signals. In one embodiment, a multiple layer touch sensing device includes a first layer and a touch key disposed on the first layer, the touch key having a first electrode and a second electrode. A second layer is coupled to the first layer and has a first trace disposed on the second layer, the first trace electrically connected to the first electrode of the touch key. A third layer is coupled to the second layer and has a second trace disposed on the third layer, the second trace electrically connected to the second electrode of the touch key.

In another embodiment, a multiple layer touch sensing input apparatus includes an electrode layer having a first ground mesh. A first touch input is located on the electrode layer and is isolated from the first ground mesh, the first touch input having a first electrode, a second electrode and a third electrode. A first layer is positioned adjacent to the electrode layer and has a second ground mesh. A first trace is located on the first layer and is isolated from the second ground mesh, the first trace connected to the first electrode of the first touch input. A second layer is positioned adjacent to the first layer and has a third ground mesh. A second trace is located on the second layer and is isolated from the third ground mesh, the second trace connected to the second electrode of the first touch input. A third layer is positioned adjacent to the second layer and has a fourth ground mesh. A third trace is located on the third layer and is isolated from the fourth ground mesh, the third trace connected to the third electrode of the first touch input.

In yet another embodiment, a method for reducing a number of signals output from a touch sensing device includes the steps of providing an electrode layer having a plurality of touch keys, providing a first layer having a first trace connected to a first portion of a first one of the plurality of touch keys and a second trace connected to a first portion of a second one of the plurality of touch keys, providing a second layer having a third trace connected to a second portion of the first one of the plurality of touch keys and a fourth trace connected to a second portion of the second one of the plurality of touch keys, allowing the transfer of a first signal along the first trace and a third signal along the third trace when a user cooperates with the first one of the plurality of touch keys, and allowing the transfer of a second signal along the second trace and a fourth signal along the fourth trace when a user cooperates with the second one of the plurality of touch keys. The user cooperating with one of the plurality of touch keys means that the user's finger (or another body part or a stylus or other device) is in physical contact with, in close proximity to, in the vicinity of, or adjacent to the touch key. In some embodiments, the user's finger does not have to be in physical contact with the touch key for the touch key to be activated or to sense the presence of the user's finger.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1A is a diagram view of an input device connected to a CPU, according to an embodiment of the invention;

FIG. 1B is a schematic view of a touch sensing input device with a vicinity-touch-electrode (“VTE”) or vicinity-touch-pin (“VTP”) connected to a CPU, according to an embodiment of the invention;

FIG. 1C is a plot view of a signal of a touch sensing input device, according to an embodiment of the invention;

FIG. 2A is a schematic view of a one dimension touch sensing input device with nine input keys, according to an embodiment of the invention;

FIG. 2B is a schematic view of a two dimension touch sensing input device with nine input keys, according to an embodiment of the invention;

FIG. 2C is a spherical model view of a three dimension touch sensing input key, according to an embodiment of the invention;

FIG. 3 is a diagram view of a two dimension touch sensing input device with nine input keys, according to an embodiment of the invention;

FIG. 4A is a top view of a plurality of one dimension touch sensing input key configurations, according to an embodiment of the invention;

FIG. 4B is a top view of a plurality of two dimension touch sensing input key configurations, according to an embodiment of the invention;

FIG. 4C is a top view of a plurality of three dimension touch sensing input key configurations, according to an embodiment of the invention;

FIG. 4D is a top view of a plurality of four dimension touch sensing input key configurations, according to an embodiment of the invention;

FIG. 4E is a top view of a plurality of five dimension touch sensing input key configurations, according to an embodiment of the invention;

FIG. 4F is a top view of a plurality of six dimension touch sensing input key configurations, according to an embodiment of the invention;

FIG. 5A is a cut-away perspective view of a three dimension touch sensing input device having various layers, according to an embodiment of the invention;

FIG. 5B is a top view of a plurality of circular overlay layers for a one dimension touch sensing input device having four input keys, according to an embodiment of the invention;

FIG. 5C is a top view of a circular electrode layer for the one dimension touch sensing input device of FIG. 5A, according to an embodiment of the invention;

FIG. 6A is a top view of a plurality of circular overlay layers for a two dimension touch sensing input device having 8 input keys, according to an embodiment of the invention;

FIG. 6B is a top view of a circular electrode layer for the two dimension touch sensing input device of FIG. 6A, according to an embodiment of the invention;

FIG. 6C is a schematic view of the two dimension touch sensing input device of FIG. 6A, according to an embodiment of the invention;

FIG. 6D is a top view of a plurality of circular overlay layers for a two dimension touch sensing input device having twelve input keys, according to an embodiment of the invention;

FIG. 6E is a top view of a circular electrode layer for the two dimension touch sensing input device of FIG. 6D, according to an embodiment of the invention;

FIG. 6F is a top view of a plurality of circular overlay layers for a two dimension touch sensing input device having sixteen input keys, according to an embodiment of the invention;

FIG. 6G is a top view of a circular electrode layer for the two dimension touch sensing input device of FIG. 6F, according to an embodiment of the invention;

FIG. 7A is a top view of a grid overlay layer for a two dimension touch sensing input device having sixteen input keys, according to an embodiment of the invention;

FIG. 7B is a top view of a grid electrode layer for the two dimension touch sensing input device of FIG. 7A, according to an embodiment of the invention;

FIG. 7C is a top view of a first trace layer for the two dimension touch sensing input device of FIG. 7A, according to an embodiment of the invention;

FIG. 7D is a top view of a second trace layer for the two dimension touch sensing input device of FIG. 7A, according to an embodiment of the invention;

FIG. 8A is a top view of a grid overlay layer for a three dimension touch sensing input device having thirty two input keys, according to an embodiment of the invention;

FIG. 8B is a top view of a grid electrode layer for the three dimension touch sensing input device of FIG. 8A, according to an embodiment of the invention;

FIG. 8C is a top view of a grid overlay layer for a three dimension touch sensing input device having twenty seven input keys, according to an embodiment of the invention;

FIG. 8D is a top view of a grid electrode layer for the three dimension touch sensing input device of FIG. 8C, according to an embodiment of the invention;

FIG. 9A is a top view of a grid overlay layer for a four dimension touch sensing input device having one hundred and twenty eight input keys, according to an embodiment of the invention; and

FIG. 9B is a top view of a grid electrode layer for the four dimension touch sensing input device of FIG. 9A, according to an embodiment of the invention.

### DETAILED DESCRIPTION

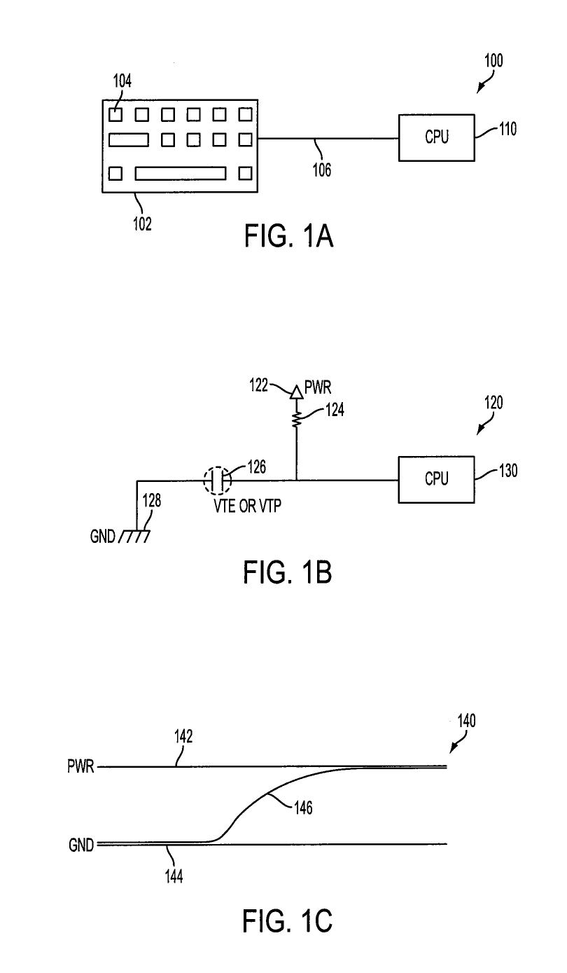

Referring to FIG. 1A, a diagram of an input system 100 is shown. An input device 102 having a plurality of user-operable keys 104 is connected to a processor or CPU 110. A signal bus 106 transfers the signals generated by pressing or touching one or more of the keys 104 to the processor or CPU 110 for further processing. This processing may be any of a variety of software operations, typically including the determination of a precise key 104 operated upon by the user and/or the initiation of some function in response to such a key 104 operation. The bus 106 may include a large number of signal lines, for example, one signal line for each key 104 present on the input device 102 or, as discussed in greater detail herein, may include fewer signal lines than the total number of keys 104 on the input device 102 via multiplexing. The input device 102 may be a mechanical input device, such as a computer keyboard, or may be a touch-based input device, such as a touch screen or other touch-sensing device that does not involve mechanical manipulations of the key 104. In some embodiments, the input device 102 may be a touch-free input or activation device that does not require the user's finger to be in physical contact with the key 104 for the key 104 to be activated or to sense the presence of the user's finger.

FIG. 1B shows a schematic representation of an electronic circuit 120 for a signal line of an electronic touch-based or touch-free input device. A processor or CPU 130 is electrically connected to a power source 122 and a ground 128 through other electronic components or circuitry. A resistor 124 is connected between the power source 122 and the processor or CPU 130. When a user is not touching an input key of the touch-based device associated with the signal line, the processor or CPU 130 sees a ground signal, such as 0 Volts, present on the signal line. When a user is touching the input key of the touch-based input device associated with the signal line, a capacitance 126 is created by the user's finger touching the input key, and the processor or CPU 130 sees a rising signal up to a maximum voltage level of the power source 122. A touch to the vicinity-touch electrode (VTE) may be between 150 ms to 250 ms. The CPU 130 is able to discharge and charge up the line or conductive path to the VTE when a human body or other electronics device (e.g., a touch pen or stylus) makes contact with the VTE. By scanning this charge up, the CPU 130 is able to detect the touch key or VTE, for example, within 100 ms. The selecting of a resistance value, combined with a filter capacitance, is designed to charge the line for less than 100 ms. Thus, the CPU 130 receives the signal from the VTE.

FIG. 1C shows one example of a signal plot 140 for a signal line corresponding to a touch-based input device. Initially, when the user is not touching an input key of the touch-based input device, the signal corresponds to the ground voltage level 144. Once a user touches the input key of the touch-based input device, the signal begins to rise 146 according to an RC time constant until the signal corresponds to the power source voltage level 142. A processor connected to this signal line may thus use the voltage level present on the connected signal line to determine whether a user is touching a particular input key associated with that signal line. FIG. 1B and/or 1C demonstrate one possible application of software and/or hardware for use with vicinity touch key concepts. Other applications may be used that utilize varying degrees of manufacturing or design simplicity or popularity. For example, other applications may use inductance or operational amplifier methods for achieving the same or similar detection of touch key manipulation. Various noise elimination and/or wrong-detection methods discussed herein will still be applicable to any or all such alternative embodiments.

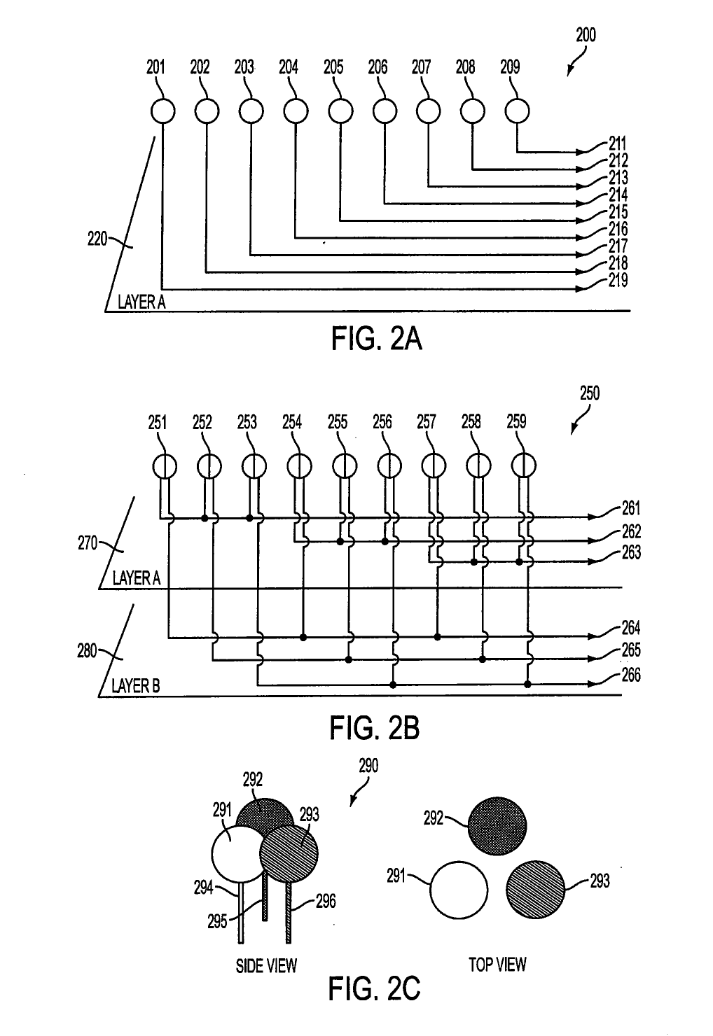

Turning next to FIG. 2A, a schematic view 200 of a one dimension touch sensing input device with nine input keys is shown. In a one dimension system, only a first layer 220 is used for the routing of signal traces associated with the various input keys or electrodes. In the schematic view 200, nine input keys (201, 202, 203, 204, 205, 206, 207, 208, 209) are shown for illustrative purposes. Each of the input keys (201, 202, 203, 204, 205, 206, 207, 208, 209) has one electrode associated with it for user interaction. Greater or fewer input keys may be utilized in alternative embodiments. The input keys (201, 202, 203, 204, 205, 206, 207, 208, 209) may be touched by a user of the one dimension touch sensing input device for inputting or otherwise transmitting or altering a corresponding output signal (211, 212, 213, 214, 215, 216, 217, 218, 219) on a signal trace located on the first layer 220. These corresponding output signals (211, 212, 213, 214, 215, 216, 217, 218, 219) may be connected to a processor or other controller for processing the output signals (211, 212, 213, 214, 215, 216, 217, 218, 219) to determine which of the input keys (201, 202, 203, 204, 205, 206, 207, 208, 209) the user is interacting with. As can be seen, a separate output signal (211, 212, 213, 214, 215, 216, 217, 218, 219) is thus needed for each corresponding input key (201, 202, 203, 204, 205, 206, 207, 208, 209), thus leading to a 1:1 relationship. Any connected processor or controller should thus have at least an equal number of pins as the number of input keys (201, 202, 203, 204, 205, 206, 207, 208, 209) for accepting the corresponding output signals (211, 212, 213, 214, 215, 216, 217, 218, 219).

FIG. 2B, in contrast, shows a schematic view 250 of a two dimension touch sensing input device with nine input keys. In a two dimension system, a first layer 270 (Layer A) and a second layer 280 (Layer B) are used for the routing of signal traces extending from the various input keys. Nine input keys (251, 252, 253, 254, 255, 256, 257, 258, 259) are shown and each of the input keys (251, 252, 253, 254, 255, 256, 257, 258, 259) has a first portion (e.g., a first electrode) and a second portion (e.g., a second electrode) associated with it. Thus, when a user touches one of the input keys (251, 252, 253, 254, 255, 256, 257, 258, 259), the user makes contact with both of the electrodes associated with that input key (251, 252, 253, 254, 255, 256, 257, 258, 259).

When touched, one or more corresponding output signals (261, 262, 263, 264, 265, 266) are transmitted or changed along one or more of the signal traces located on the first layer 270 and/or the second layer 280. The output signals (261, 262, 263, 264, 265, 266) may be transmitted to a processor or other controller for processing in order to determine which of the input keys (251, 252, 253, 254, 255, 256, 257, 258, 259) the user is interacting with. The user interacting with one of the input keys means that the user's finger (or another body part or a stylus or other device) is in physical contact with, in close proximity to, in the vicinity of, or adjacent to the touch key. In some embodiments, the user's finger does not have to be in physical contact with the input key for the input key to be activated or to sense the presence of the user's finger.

In this illustration, only six output signals (261, 262, 263, 264, 265, 266) are needed to properly identify the nine input keys (251, 252, 253, 254, 255, 256, 257, 258, 259). For example, when a user touches the input key 251, the output signal 261 is transmitted along a signal trace on the first layer 270 and the output signal 264 is transmitted along a signal trace on the second layer 280. A processor connected to these signal traces would thus be able to recognize that input key 251 was being touched based upon the output signals being received. As can be seen, the strict 1:1 relationship between input keys and output signals is no longer required for a two dimensional system and a connected processor or controller may utilize fewer input pins for determining whether a given input key is being pressed. Similar to the discussion above, greater or fewer input keys may be used in an alternative embodiment.

As a further illustration, FIG. 2C shows a spherical model view of a three dimension touch sensing input key 290. A three dimension touch sensing input key utilizes at least three conductive portions or elements configured to be manipulated by a user when interacting with the input key 290. A first conductive element or electrode 291, a second conductive element or electrode 292 and a third conductive element or electrode 293 are arranged or configured to form the input key 290. Thus, when a user presses or touches the input key 290 or a corresponding area adjacent to the input key 290, the user manipulates or interacts with each of the first electrode 291, the second electrode 292 and the third electrode 293. A first signal line 294 is connected to the first electrode 291. A second signal line 295 is connected to the second electrode 292. A third signal line 296 is connected to the third electrode 293. The signal lines (294, 295, 296) may electrically connect the electrodes (291, 292, 293) to a connected processor or controller configured to determine when a user is interacting with the input key 290 based upon changes in a signal present upon the signal lines (294, 295, 296).

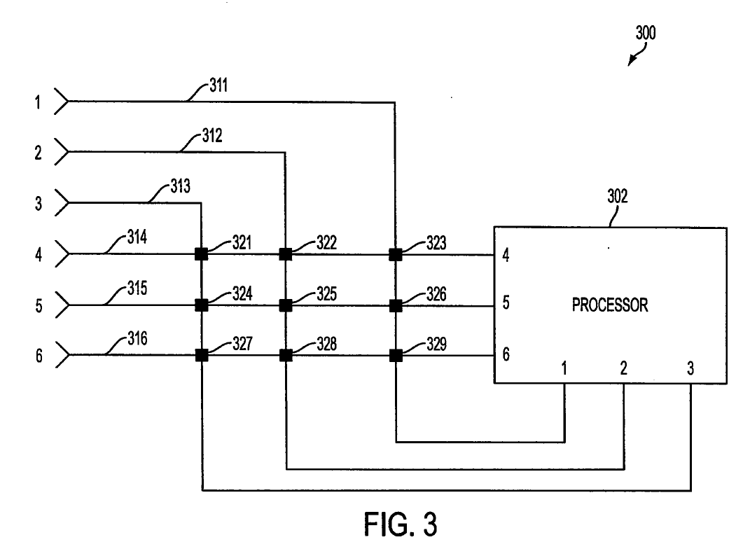

As another illustration, FIG. 3 shows a diagram view 300 of a two dimension touch sensing input device with nine input keys and only utilizing six input pins of a connected processor 302. Six signal lines (311, 312, 313, 314, 315, 316) connect to the processor 302 at six input pins. Nine manipulatable inputs (321, 322, 323, 324, 325, 326, 327, 328, 329) may thus be accommodated by the two dimension system as shown. For example, when a user manipulates or interacts with the input 321, the processor 302 recognizes or responds to a signal change on signal line 313 and on signal line 314, connected to pin 3 and pin 4, respectively, of the processor 302.

As demonstrated by FIGS. 2A and 2B, a two dimension touch sensing device can lower the number of input pins required on a processor without also lowering the number of input keys that can be accommodated. As additional signal trace layers are added to thus create three dimension, four dimension, five dimension, six dimension, etc, touch sensing devices, the number of input keys may be substantially increased without the associated 1:1 increase in the number of input pins on a connected processor, in contrast to a current one dimension system. Indeed, an alternative embodiment may utilize any number of dimensional layers for the routing of signal traces as desired by system design constraints or other requirements.

One method of determining, for example during the design stage of a touch sensing input device, the number of output signals required or the number of pins needed on a connected processor is shown by the following equation or formula:

VTP=VTS*VTD

wherein VTP is the number of touchpins, VTS is the number of signal traces per signal trace layer, and VTD is the dimensionality of the touch sensing device (i.e., the total number of signal trace layers). In one example, if a touch sensing device was designed to have six signal traces per signal trace layer and a dimensionality of four (i.e., four signal trace layers), then the required number of touchpins needed for the touch sensing input device would be twenty four. If an unequal number of signal traces per signal trace layer is desired, then a designer should sum the total number of signal traces on every layer to arrive at the number of processor pins needed. A touchpin (VTP) used in a touch sensing input device may include one or more electrodes (VTE). For example, a touch sensing device of dimension 1 may have one touchpin (VTP) that uses one electrode (VTE). In another example, a touch sensing device of dimension 2 may have one touchpin (VTP) that uses two electrodes (VTE). In still another example, a touch sensing device of dimension 3 may have one touchpin (VTP) that uses three electrodes (VTE). As can thus be seen, a designer may easily scale the number of electrodes (VTE) used for each touchpin (VTP) depending upon any desired dimensionality of the touch sensing input device.

One method of determining the number of input keys obtainable is shown by the following equations or formulas:

VTE=(VTS)̂(VTD) or

VTD*log(VTS)=log(VTE)

wherein VTE is the number of electrodes for the touch sensing input device, VTS is the number of signal traces per signal trace layer, and VTD is the dimensionality of the touch sensing input device (i.e., the total number of signal trace layers). In one example, if a touch sensing input device was designed to have six signal traces per signal trace layer and a dimensionality of four (i.e., four signal trace layers), then the maximum number of electrodes obtainable is one thousand, two hundred and ninety six keys. If an unequal number of signal traces per layer are desired, then a designer should multiply together the number of signal traces for each signal trace layer.

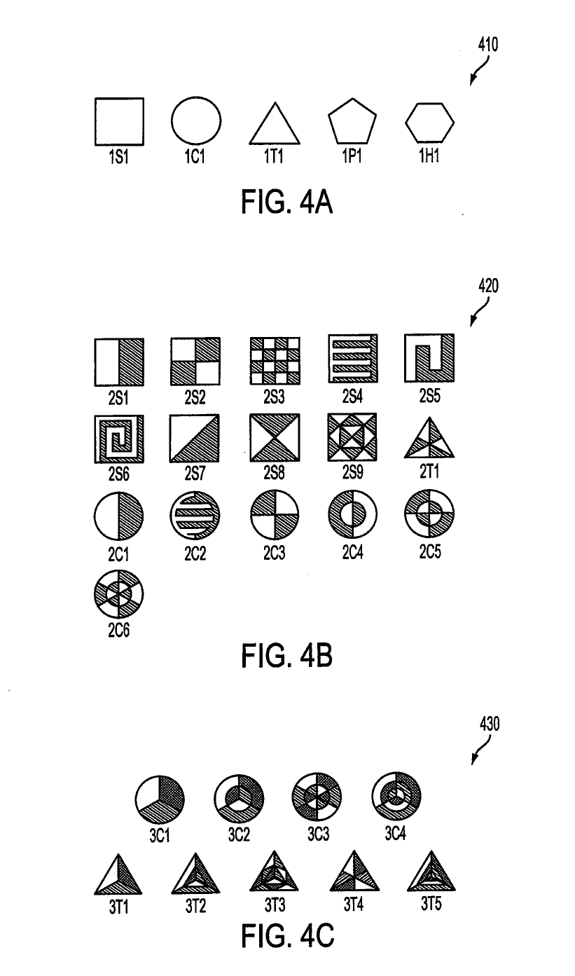

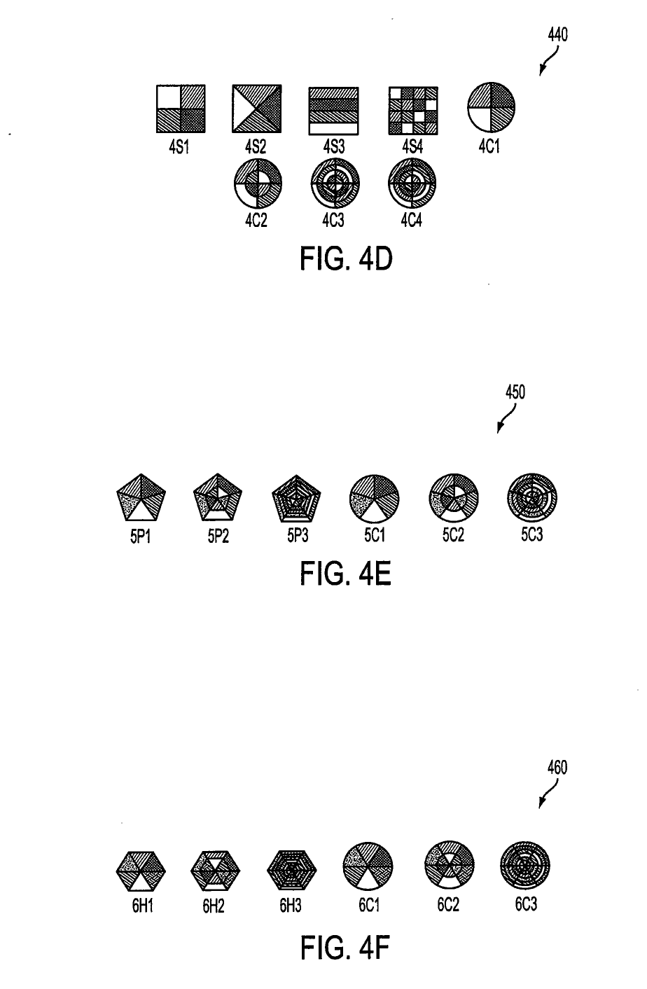

Turning next to FIGS. 4A-4F, a variety of touch sensing input key configurations are shown. FIG. 4A illustrates a variety of input keys 410 with one dimension functionality. The input keys 410 of FIG. 4A thus have only one associated electrode for each input key 410 since only one signal trace layer is to be utilized. FIG. 4B illustrates a variety of the input keys 420 with two dimension functionality. The input keys 420 of FIG. 4B thus have two associated electrodes for each input key 420 since two signal trace layers are to be utilized. FIG. 4C illustrates a variety of the input keys 430 for three dimension functionality. The input keys 430 of FIG. 4C thus have three associated electrodes for each input key 430 since three signal trace layers are to be utilized. FIG. 4D illustrates a variety of the input keys 440 for four dimension functionality. The input keys 440 of FIG. 4D thus have four associated electrodes for each input key 440 since four signal trace layers are to be utilized. FIG. 4E illustrates a variety of the input keys 450 for five dimension functionality. The input keys 450 of FIG. 4E thus have five associated electrodes for each input key 450 since five signal trace layers are to be utilized. FIG. 4F illustrates a variety of the input keys 460 for six dimension functionality. The input keys 460 of FIG. 4F thus have six associated electrodes for each input key 460 since six signal trace layers are to be utilized. In alternative embodiments, any number of dimension functionality may be obtained by designing and/or using input keys with any number of associated electrodes.

The various input keys described for each of the FIGS. 4A-4F are shown with a variety of overall shapes, including a square or rectangle, a circle or oval, a triangle, a pentagon, or a hexagon. In an alternative embodiment, any shape may be utilized for a given touch key as desired. Certain shapes may provide better sensitivity to user touch, but at varying manufacturing costs. Each of the various input keys has been configured such that all the electrodes associated with a given input key can be touched or otherwise make electrical contact with the user in order to appropriately transmit an associated or corresponding output signal or signals for the given input key, as described in greater detail above for FIGS. 2A-2C. This is preferably accomplished by spacing the various electrodes along the touchable surface of each input key such that a user who only touches a portion of the input key will still appropriately contact at least one of each of the electrodes needed for a connected processor to appropriately respond to the transmitted output signals. Certain configurations of electrodes may provide increased sensitivity to touch, but at increased manufacturing cost.

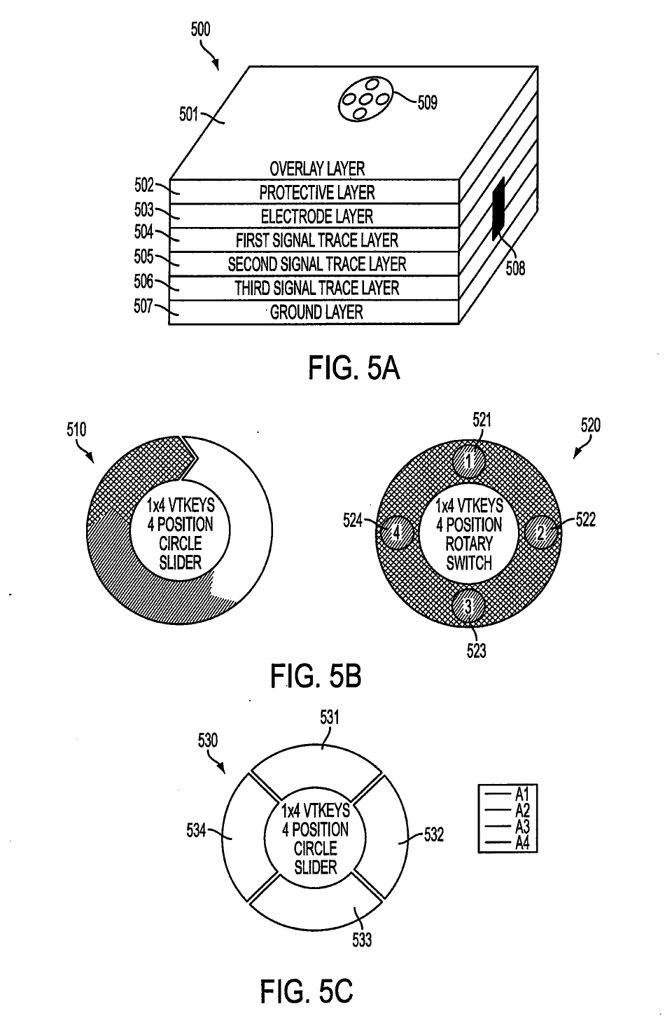

When creating a touch sensing input device, such as a keyboard, it is often desirable to inform a user where the input keys are located or positioned so that the user may appropriately interface with the device. This may be accomplished by providing an overlay layer, disposed above or adjacent to a layer containing the electrodes of the input keys. FIG. 5A shows a diagram view of the various layers of a three dimensional touch sensing input device 500. An overlay layer 501 is positioned on top such that a user of the touch sensing input device 500 may recognize the locations of various input keys and touch or manipulate the touch sensing input device 500 accordingly on one or more key representations 509. The key representations 509 may be printed on the overlay layer 501 using ink or any other visible material. A protective layer 502 may be coupled or positioned adjacent or beneath the overlay layer 501 for the purposes of helping reduce damage to the subsequent layers of the touch sensing input device when a force impacts the touch sensing input device 500. This protective layer 502 may be glass or any other material or materials that would aid in damage prevention when user handles the touch sensing input device 500 roughly, drops the touch sensing input device 500, or otherwise exhibits a force upon the touch sensing input device 500. In an alternative embodiment, the overlay layer 501 and the protective layer 502 may swap positions such that the protective layer 502 is positioned or located above the overlay layer 501.

The overlay layer 501 may be configured such that a user of the touch sensing input device 500 is permitted to remove and/or replace the overlay layer 501. Such a system allows a user the flexibility to swap a used overlay with a similar new overlay if the used overlay becomes damaged or worn from use. In addition, the user may replace one overlay with a different overlay, allowing for the user to utilize a variety of compatible overlay layers for a given underlying electrode layer. This may be desired, for example, on computer systems where different applications run by a computer respond differently to the touching of the same input keys. For example, one application run by the computer may be a calculator, such that upon touching one of the key representations 509, the user expects to see a number entered on the computer screen. A second application run by the computer may instead use the location of the key representation 509 as a “volume up” command. A user-swappable overlay with the key representation 509 instead labeled with “Volume Up” instead of a number could replace the original overlay layer 501 if so desired. Alternatively, the overlay layer 501 may not be replaceable by the user, but a variety of overlay layers may be designed to be compatible with a single electrode layer configuration. This may lower the manufacturing cost for a line of differing input devices since only the overlay layer 501 needs to be altered or modified for those differing touch devices.

An electrode layer 503 for including or accommodating the electrodes of the various input keys (see discussion above for FIG. 2A-2C) is coupled or positioned adjacent to the protective layer 502. The electrodes of the various input keys are positioned on the electrode layer 503 to correspond with the key representation 509 that is printed on the overlay layer 501. For example, if the overlay layer 501 indicates an input key is positioned in the top center of the touch sensing input device 500, a corresponding input key having one or more electrodes is so positioned in or on the electrode layer 503. A first signal trace layer 504 is coupled or positioned adjacent to the electrode layer 503 and is used for routing signals along signal traces on or in the first signal trace layer 504 between one or more electrodes on the electrode layer 503 and an output connector 508. A second signal trace layer 505 is coupled or positioned adjacent to the first signal trace layer 504 and is used for routing signals along signal traces on or in the second signal trace layer 505 between one or more electrodes on the electrode layer 503 and the output connector 508. A third signal trace layer 506 is coupled or positioned adjacent to the second signal trace layer 505 and is used for routing signals along signal traces on or in the third signal trace layer 506 between one or more electrodes on the electrode layer 503 and the output connector 508. A ground layer 507 for reducing signal interference, as discussed in greater detail herein, is coupled or positioned adjacent to the third signal trace layer 506. In an alternative embodiment, any number of signal trace layers may be utilized depending upon the desired dimensionality of the touch sensing device. In addition, the relative ordering or positioning of the various layers may be different in an alternative embodiment. Additional or fewer layers may be utilized in an alternative embodiment, in the same or differing ordering.

FIG. 5B shows top views of two circular overlay layers for a one dimension touch sensing input device having four input keys and using four pins of a connected processor (i.e., 1×4 signal lines). A circle slider overlay layer 510 may be used to indicate that a user may place and slide or rotate their finger along the overlay path as shown. A circle rotary switch overlay layer 520 may be used to indicate the presence and location of four direct access touch inputs via the printed key representations (521, 522, 523, 524) so that the user may directly interface with a desired input key.

FIG. 5C shows a top view of an electrode layer 530 that corresponds to the circle slider overlay layer 510 for the one dimension touch sensing input device of FIG. 5B. Aspects of the electrode layer 530 may have been designed using any of the methods or equations discussed above for determining the number of electrodes needed and/or the configuration of electrodes for sensitivity of touch. The electrode layer 530 includes four touch inputs (531, 532, 533, 534), each of the touch inputs (531, 532, 533, 534) having one electrode due to the one dimensionality of the touch inputs (531, 532, 533, 534). For one dimension functionality, each of the electrodes may be connected directly to a pin of a connected processor. By positioning the electrode layer 530 beneath the circle slider overlay layer 510, a user that slides their finger along the entire overlay path shown will make subsequent electrical contact with the four touch inputs (531, 532, 533, 534), thus indicating to a processor connected to signal traces (A1, A2, A3, A4) the movement of the user's finger. In an alternative embodiment, the electrode layer 530 may be positioned beneath and correspond to the circle rotary switch overlay layer 520. The touch inputs (531, 532, 533, 534) may also be sized and/or oriented in a different configuration to more closely match the printed key representations (521, 522, 523, 524) of the circle rotary switch overlay layer 520. A ground plane, as discussed in greater detail herein, may be disposed on the electrode layer 530 in areas isolated from the four touch inputs (531, 532, 533, 534).

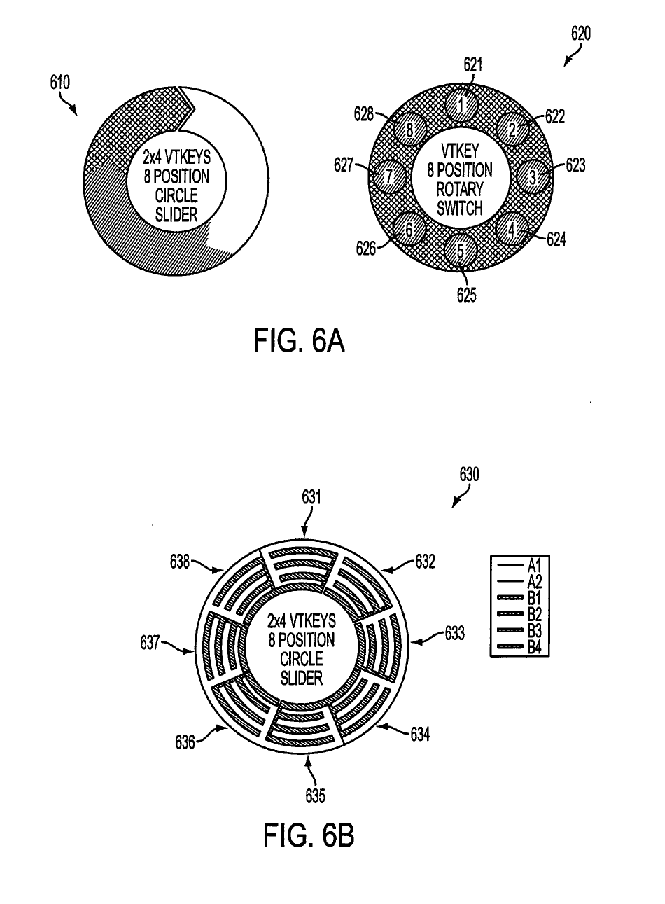

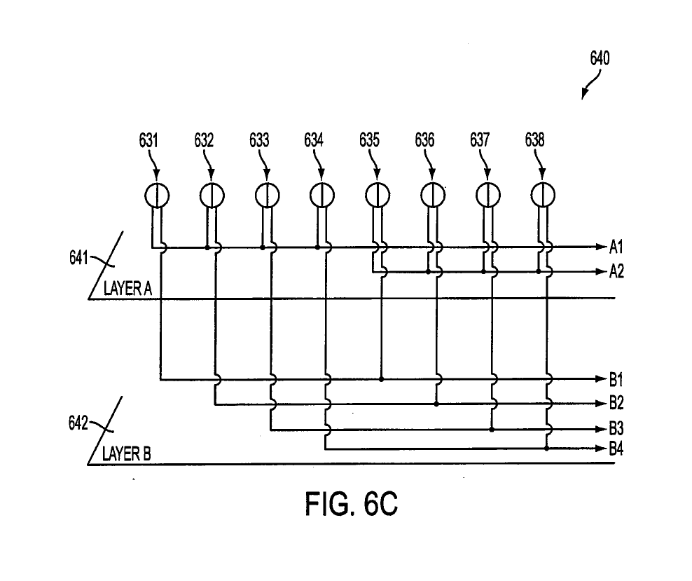

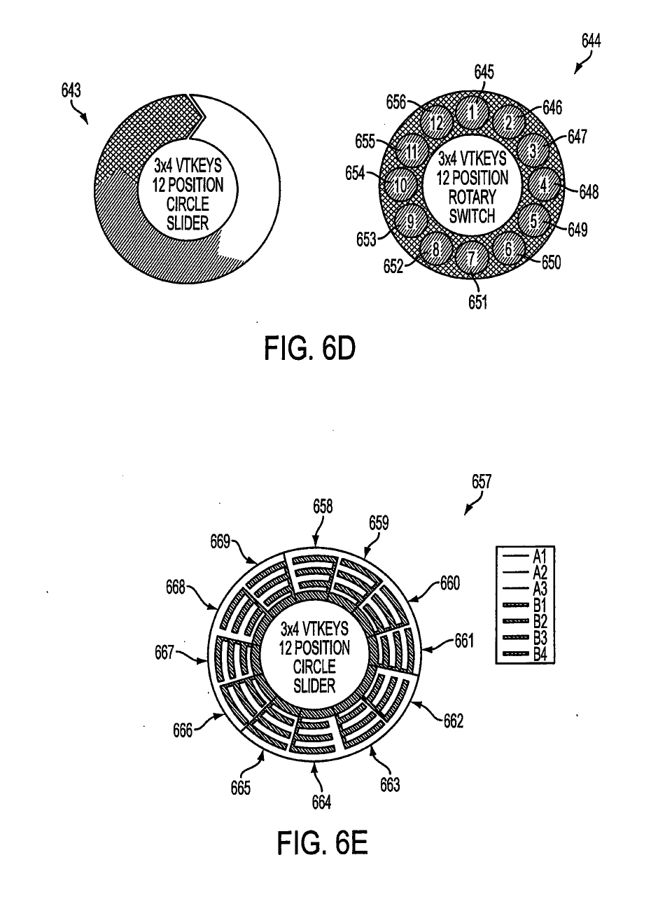

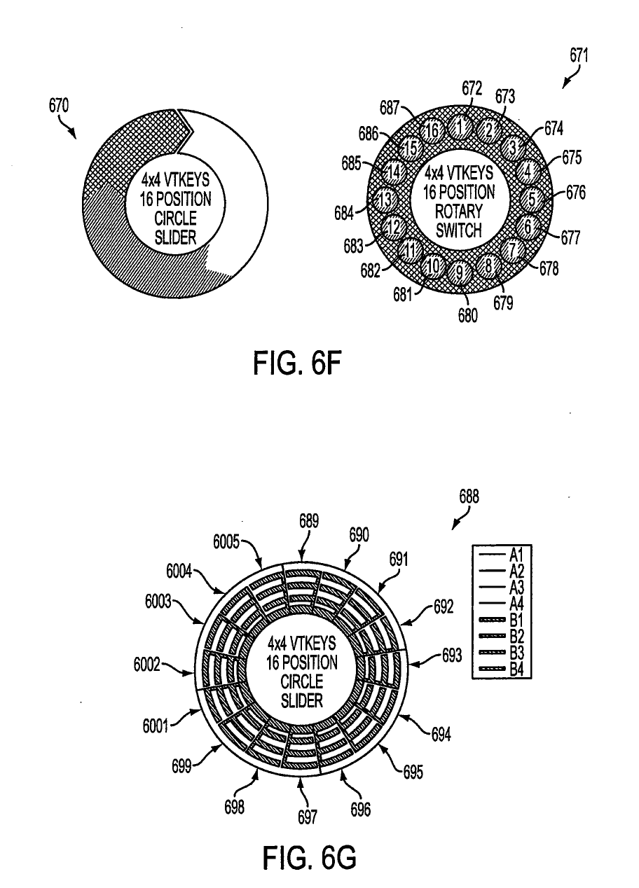

FIG. 6A shows top views of two circular overlay layers for a two dimension touch sensing input device having eight input keys and using six pins of a connected processor (i.e., 2×4 signal lines). Similar to the circle slider overlay layer 510 (see FIG. 5B), a circle slider overlay layer 610 may be used to indicate that a user may place and slide or rotate their finger along the overlay path shown. Similar to the circle slider overlay layer 520, a circle rotary switch overlay layer 620 may be used to indicate the presence and location of eight direct access touch inputs via the printed key representations (621, 622, 623, 624, 625, 626, 627, 628) so that the user may directly interface with a desired input key.

FIG. 6B shows a top view of an electrode layer 630 that corresponds to the circle slider overlay layer 610 of the two dimension touch sensing input device of FIG. 6A. Aspects of the electrode layer 630 may have been designed using any of the methods or equations discussed above for determining the number of electrodes needed and/or the configuration of electrodes for sensitivity of touch. The electrode layer 630 includes eight touch inputs (631, 632, 633, 634, 635, 636, 637, 638), each of the touch inputs (631, 632, 633, 634, 635, 636, 637, 638) having two electrodes due to the two dimensionality of the touch inputs (631, 632, 633, 634, 635, 636, 637, 638), and thus using only six processing lines or signal traces (A1, A2, B1, B2, B3, B4). By positioning the electrode layer 630 beneath the circle slider overlay layer 610, a user that slides their finger along the entire overlay path shown will make subsequent electrical contact with the eight touch inputs (631, 632, 633, 634, 635, 636, 637, 638), thus indicating to a processor connected to signals traces (A1, A2, B1, B2, B3, B4) the movement of the user's finger. In an alternative embodiment, the electrode layer 630 may be positioned beneath and correspond to the circle rotary switch overlay layer 620. The touch inputs (631, 632, 633, 634, 635, 636, 637, 638) may also be sized and/or oriented in a different configuration to more closely match the printed key representations (621, 622, 623, 624, 625, 626, 627, 628) of the circle rotary switch overlay 620. A ground plane, as discussed in greater detail herein, may be disposed on the electrode layer 630 in areas isolated from the eight touch inputs (631, 632, 633, 634, 635, 636, 637, 638).

To further illustrate, FIG. 6C shows a schematic view 640 of the two dimension touch sensing input device for FIG. 6A and FIG. 6B. The touch inputs (631, 632, 633, 634, 635, 636, 637, 638) each have two electrodes, the electrodes connected to various signal traces (A1, A2, B1, B2, B3, B4) located either on a first signal layer 641 or a second signal layer 642. Alternative embodiments may utilize any dimensionality as desired for a particular design. For example, designs using between five and sixteen touch inputs may utilize two dimension functionality. In another example, designs using between seventeen and sixty four touch inputs may utilize three dimension functionality.

FIG. 6D shows top views of two circular overlay layers for a two dimension touch sensing input device having twelve input keys and using seven pins of a connected processor (i.e., 3×4 signal lines). While circle slider and/or rotary switch touch key configurations generally require four, eight, sixteen, or thirty two positions, utilizing the multilayer and/or multiplexing of signal lines as discussed can support alternative positions numbers, such as twelve, in certain embodiments. Similar to the circle slider overlay layer 610 (see FIG. 6A), a circle slider overlay layer 643 may be used to indicate that a user may place and slide or rotate their finger along the overlay path shown. Similar to the circle rotary switch overlay layer 620 (see FIG. 6A), a circle rotary switch overlay layer 644 may be used to indicate the presence and location of twelve direct access touch inputs via the printed key representations (645, 646, 647, 648, 649, 650, 651, 652, 653, 654, 655, 656) so that the user may directly interface with a desired input key. Certain aspects of the circle slider overlay layer 643 and/or the circle rotary switch overlay layer 644 may be the same or similar to those overlay layers previously discussed.

FIG. 6E shows a top view of an electrode layer 657 that corresponds to the circle slider overlay layer 643 of the two dimension touch sensing input device of FIG. 6D. Aspects of the electrode layer 657 may have been designed using any of the methods or equations discussed above for determining the number of electrodes needed and/or the configuration of electrodes for sensitivity of touch. The electrode layer 657 includes twelve touch inputs (658, 659, 660, 661, 662, 663, 664, 665, 666, 667, 668, 669), each of the touch inputs (658, 659, 660, 661, 662, 663, 664, 665, 666, 667, 668, 669) having two electrodes due to the two dimensionality of the touch inputs (658, 659, 660, 661, 662, 663, 664, 665, 666, 667, 668, 669), and thus using only seven processing lines or signal traces (A1, A2, A3, B1, B2, B3, B4). By positioning the electrode layer 657 beneath the circle slider overlay layer 643, a user that slides their finger along the entire overlay path shown will make subsequent electrical contact with the twelve touch inputs (658, 659, 660, 661, 662, 663, 664, 665, 666, 667, 668, 669), thus indicating to a processor connected to signals traces (A1, A2, A3, B1, B2, B3, B4) the movement of the user's finger. In an alternative embodiment, the electrode layer 657 may be positioned beneath and correspond to the circle rotary switch overlay layer 644. The touch inputs (658, 659, 660, 661, 662, 663, 664, 665, 666, 667, 668, 669) may also be sized and/or oriented in a different configuration to more closely match the printed key representations (645, 646, 647, 648, 649, 650, 651, 652, 653, 654, 655, 656) of the circle rotary switch overlay layer 644. A ground plane, as discussed in greater detail herein, may be disposed on the electrode layer 657 in areas isolated from the twelve touch inputs (658, 659, 660, 661, 662, 663, 664, 665, 666, 667, 668, 669). Certain aspects of the electrode layer 657 may be the same or similar to electrode layers previously discussed.

FIG. 6F shows top views of two circular overlay layers for a two dimension touch sensing input device having sixteen input keys and using eight pins of a connected processor (i.e., 4×4 signal lines). Similar to the circle slider overlay layer 610 (see FIG. 6A), a circle slider overlay layer 670 may be used to indicate that a user may place and slide or rotate their finger along the overlay path shown. Similar to the circle rotary switch overlay layer 620 (see FIG. 6A), a circle rotary switch overlay layer 671 may be used to indicate the presence and location of sixteen direct access touch inputs via the printed key representations (672, 673, 674, 675, 676, 677, 678, 679, 680, 681, 682, 683, 684, 685, 686, 687) so that the user may directly interface with a desired input key. Certain aspects of the circle slider overlay layer 670 and/or the circle rotary switch overlay layer 671 may be the same or similar to overlay layers previously discussed.

FIG. 6G shows a top view of an electrode layer 688 that corresponds to the circle slider overlay layer 670 of the two dimension touch sensing input device of FIG. 6F. Aspects of the electrode layer 688 may have been designed using any of the methods or equations discussed above for determining the number of electrodes needed and/or the configuration of electrodes for sensitivity of touch. The electrode layer 688 includes sixteen touch inputs (689, 690, 691, 692, 693, 694, 695, 696, 697, 698, 699, 6001, 6002, 6003, 6004, 6005), each of the touch inputs (689, 690, 691, 692, 693, 694, 695, 696, 697, 698, 699, 6001, 6002, 6003, 6004, 6005) having two electrodes due to the two dimensionality of the touch inputs (689, 690, 691, 692, 693, 694, 695, 696, 697, 698, 699, 6001, 6002, 6003, 6004, 6005), and thus using only eight processing lines or signal traces (A1, A2, A3, A4, B1, B2, B3, B4). By positioning the electrode layer 688 beneath the circle slider overlay layer 670, a user that slides their finger along the entire overlay path shown will make subsequent electrical contact with the sixteen touch inputs (689, 690, 691, 692, 693, 694, 695, 696, 697, 698, 699, 6001, 6002, 6003, 6004, 6005), thus indicating to a processor connected to signals traces (A1, A2, A3, A4, B1, B2, B3, B4) the movement of the user's finger. In an alternative embodiment, the electrode layer 688 may be positioned beneath and correspond to the circle rotary switch overlay layer 671. The touch inputs (689, 690, 691, 692, 693, 694, 695, 696, 697, 698, 699, 6001, 6002, 6003, 6004, 6005) may also be sized and/or oriented in a different configuration to more closely match the printed key representations (672, 673, 674, 675, 676, 677, 678, 679, 680, 681, 682, 683, 684, 685, 686, 687) of the circle rotary switch overlay layer 671. A ground plane, as discussed in greater detail herein, may be disposed on the electrode layer 688 in areas isolated from the sixteen touch inputs (689, 690, 691, 692, 693, 694, 695, 696, 697, 698, 699, 6001, 6002, 6003, 6004, 6005). Certain aspects of the electrode layer 688 may be the same or similar to electrode layers previously discussed.

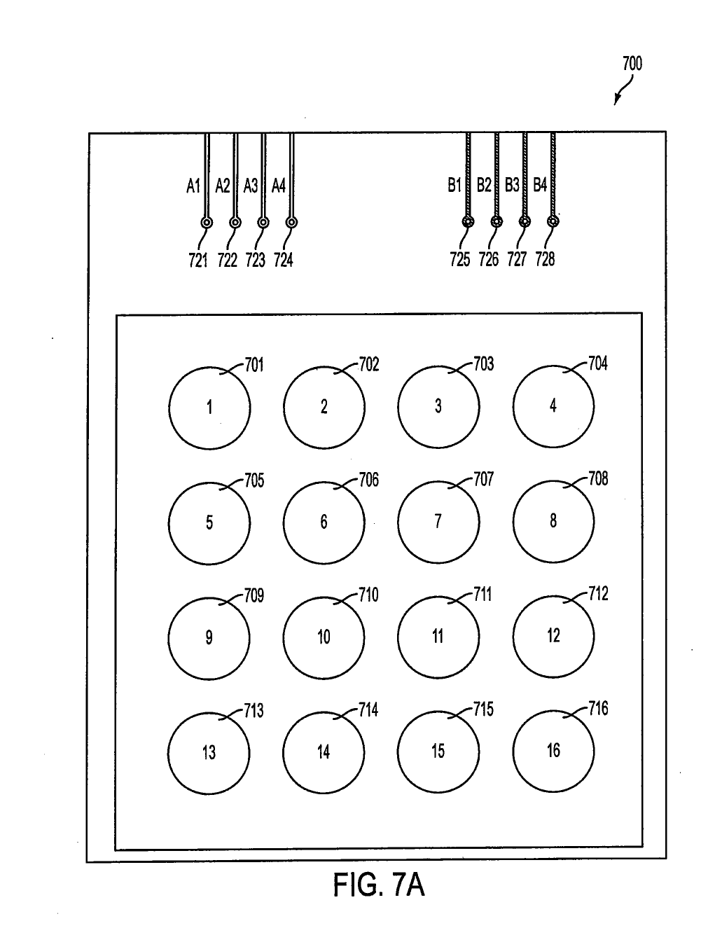

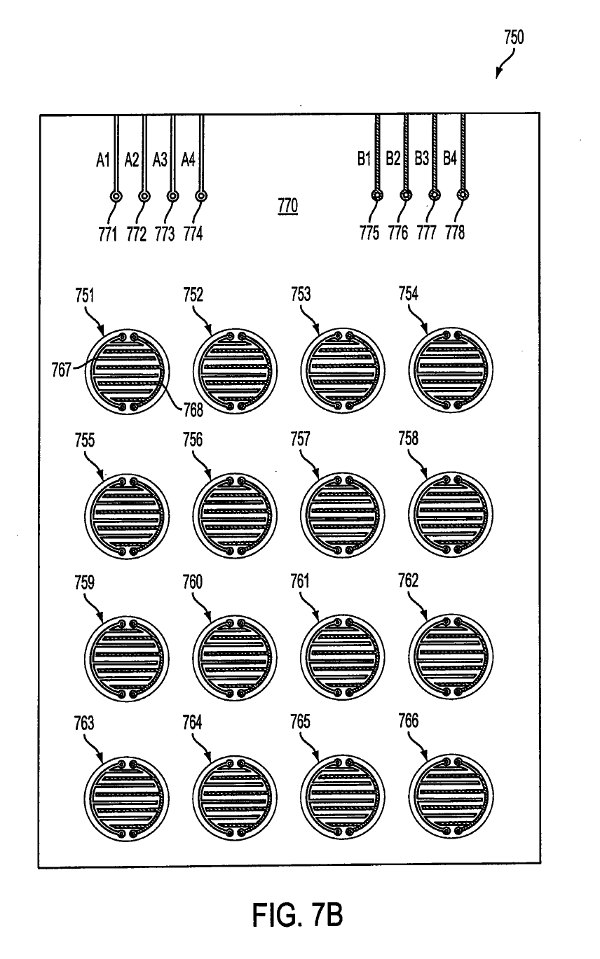

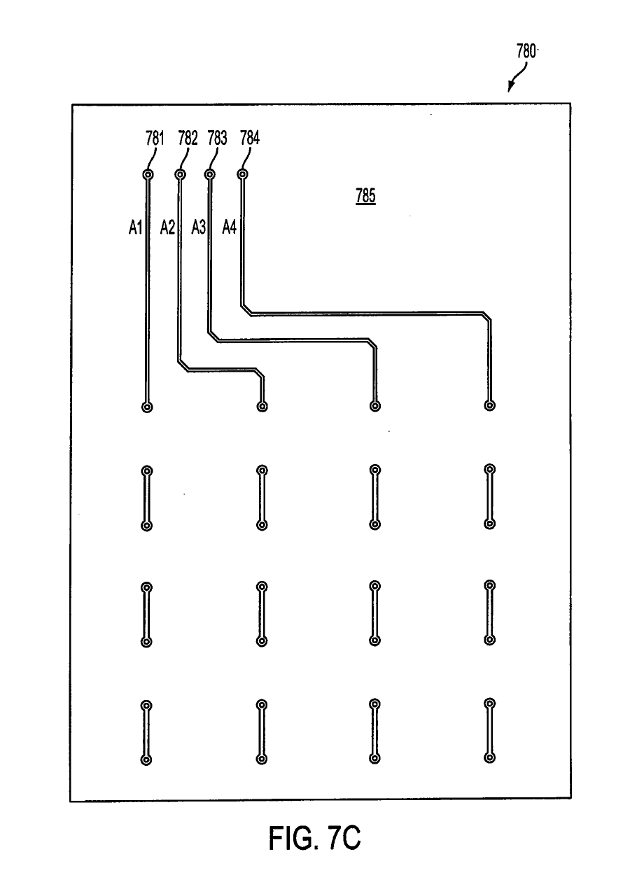

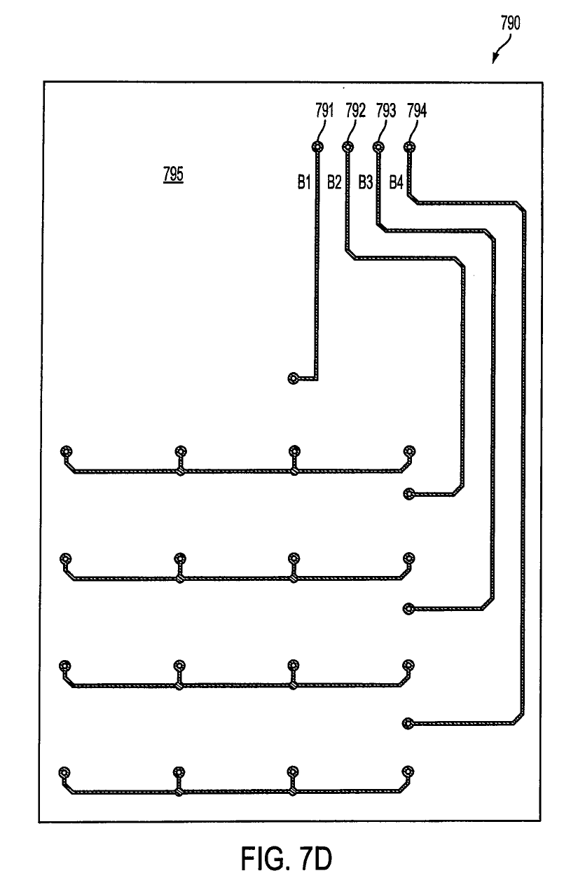

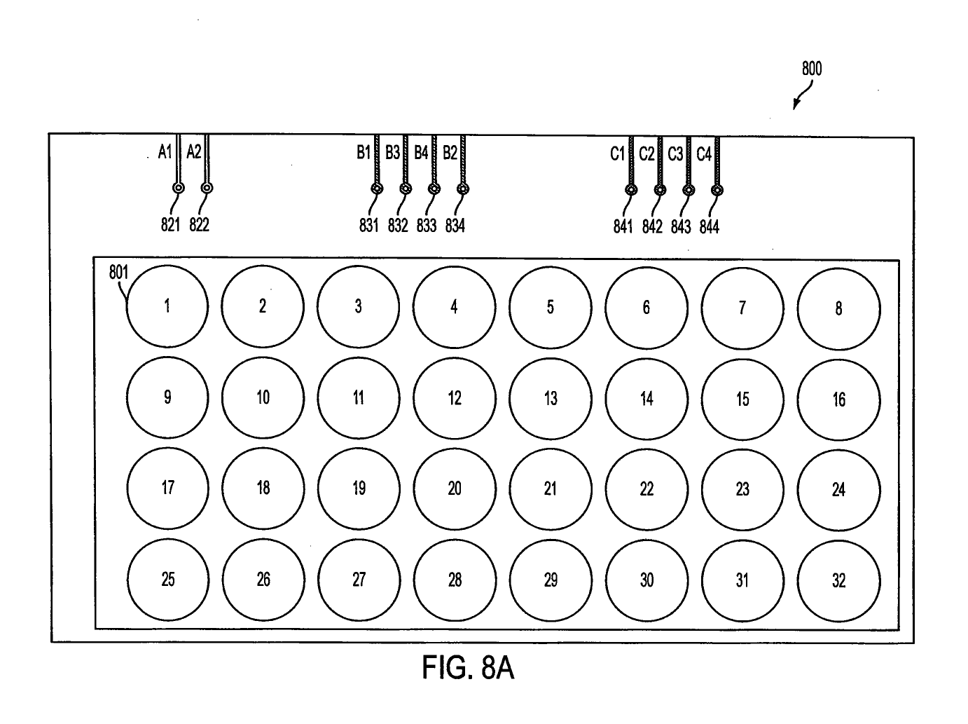

A variety of other configurations for touch inputs or input keys, in replacement of or in addition to circle sliders to rotary switches, may be used. In one embodiment, a two dimensional touch sensing device may have its input keys configured in a direct touch grid formation, such as that shown in FIG. 7A. FIG. 7A shows a top view of a grid overlay layer 700 for a two dimension touch sensing input device having sixteen touch sensing inputs while requiring only eight pins (i.e. 4×4 signal lines) on a connected processor. A corresponding electrode layer 750 is shown in FIG. 7B, as discussed in greater detail herein. An associated first signal trace layer 780 is shown in FIG. 7C and an associated second signal trace layer 790 is shown in FIG. 7D, as discussed in greater detail herein.

Looking first to the grid overlay layer 700 of FIG. 7A, a plurality of sixteen key representations (701, 702, 703, 704, 705, 706, 707, 708, 709, 710, 711, 712, 713, 714, 715, 716) are printed or otherwise disposed upon the grid overlay layer 700. The associated output signal representations (721, 722, 723, 724, 725, 726, 727, 728) are also printed or otherwise disposed upon the grid overlay layer 700. A user of a touch sensing device incorporating the grid overlay layer 700 would thus expect to interact with sixteen different inputs located at the positions of the printed key representations (701, 702, 703, 704, 705, 706, 707, 708, 709, 710, 711, 712, 713, 714, 715, 716). Although a rectangular shaped grid overlay layer 700 layer is shown in FIG. 7A, the geometry or shape of the grid overlay layer 700 may be of any desired shape or configuration.

Looking next to the electrode layer 750 of FIG. 7B, a plurality of sixteen input keys (751, 752, 753, 754, 755, 756, 757, 758, 759, 760, 761, 762, 763, 764, 765, 766) are positioned substantially beneath the sixteen key representations (701, 702, 703, 704, 705, 706, 707, 708, 709, 710, 711, 712, 713, 714, 715, 716) of the grid overlay layer 700. Each of the sixteen input keys (751, 752, 753, 754, 755, 756, 757, 758, 759, 760, 761, 762, 763, 764, 765, 766) uses a circular or spherical model for establishing the sensitivity of each key and has two associated electrodes (767, 768) for the two dimension touch sensing functionality. Thus, when a user places their finger on the key representation 701 on the grid overlay layer 700, electrical contact is also made with both of the electrodes (767, 768) of the input key 751. The electrodes (767, 768) may be made of any conductive material, such as copper. The configuration of the electrodes (767, 768) for a given two dimensional input key 751 may be the same or similar to, for example, any of the input keys 420 shown for FIG. 4B and selected so as to provide a desired balance between touch sensitivity and manufacturing cost. The electrode layer 750 may be a printed circuit board, or, alternatively, any type of material layer that permits conductive elements to be included on or in the material. Although a rectangular shaped electrode layer 750 is shown in FIG. 7B, the geometry or shape of the electrode layer 750 may be of any desired shape or configuration in an alternative embodiment.

The electrode layer 750 also includes the output signal traces (771, 772, 773, 774, 775, 776, 777, 778) for transmitting one or more signals along signal traces in subsequent layers, discussed in greater detail herein, to a connector, processor or other controller. The output signal traces (771, 772, 773, 774, 775, 776, 777, 778) may connect directly to the processor if the processor is included as part of the touch sensing device. Alternatively, the output signal traces (771, 772, 773, 774, 775, 776, 777, 778) may conduct through an output connector for interfacing with a processor positioned outside of the touch sensing device.

The processor may be any type of hardware or circuit capable of performing the necessary processing steps, for example, a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The remaining surface area of the electrode layer 750 not taken up by the input keys (751, 752, 753, 754, 755, 756, 757, 758, 759, 760, 761, 762, 763, 764, 765, 766) or the output signal traces (771, 772, 773, 774, 775, 776, 777, 778) is covered with or otherwise incorporates a ground mesh 770 that is isolated from the input keys (751, 752, 753, 754, 755, 756, 757, 758, 759, 760, 761, 762, 763, 764, 765, 766) and the output signal traces (771, 772, 773, 774, 775, 776, 777, 778). The ground mesh 770 operates to prevent undesired or unintended electrical interference from a user touching the touch sensing device in areas other than the input keys (751, 752, 753, 754, 755, 756, 757, 758, 759, 760, 761, 762, 763, 764, 765, 766). Since signal traces in subsequent layers are routed along various surface areas of the subsequent signal trace layers, a user's touch over one of those signal traces may otherwise couple and interfere with the signal if no ground mesh 770 were present. By placing the ground mesh 770 everywhere upon the electrode layer 750 except for the locations of the input keys (751, 752, 753, 754, 755, 756, 757, 758, 759, 760, 761, 762, 763, 764, 765, 766) and output signal traces (771, 772, 773, 774, 775, 776, 777, 778), handling by a user in areas other than the input keys (751, 752, 753, 754, 755, 756, 757, 758, 759, 760, 761, 762, 763, 764, 765, 766) and output signal traces (771, 772, 773, 774, 775, 776, 777, 778) will not induce signal changes on the signal traces in subsequent layers beneath the ground mesh 770. Thus, the ground mesh 770 prevents those signal traces from being effected by the user except at the predetermined input key (751, 752, 753, 754, 755, 756, 757, 758, 759, 760, 761, 762, 763, 764, 765, 766) locations.

The first signal trace layer 780 shown on FIG. 7C operates to route signals along first layer signal traces (781, 782, 783, 784) located on the first signal trace layer 780 of the touch sensing device. For example, when a user manipulates the input key 751, a signal is transmitted along the first signal trace 781 due to the user's finger cooperating with a first of the two electrodes (e.g., electrode 676) of the input key 751. When a user manipulates the input key 752, a signal is transmitted along the second signal trace 782 due to the user's finger cooperating with a first of the two electrodes of the input key 752. When a user manipulates the input key 753, a signal is transmitted along the third signal trace 783 due to the user's finger cooperating with a first of the two electrodes of the input key 753. When a user touches the input key 754, a signal is transmitted along the fourth signal trace 784 due to the user's finger cooperating with a first of the two electrodes of the input key 754. The first layer signal traces (781, 782, 783, 784) electrically connect with output signal traces (771, 772, 773, 774) of the electrode layer 750 through conductive vias that extend between the layers. Similar to the discussion above for the electrode layer 750, a ground mesh 785 is incorporated on the remaining surface area of the first signal trace layer 780 and is isolated from the first layer signal traces (781, 782, 783, 784) to help in isolating signal traces in adjacent layers. In an alternative embodiment, no ground mesh may be needed. The first signal trace layer 780 may be a printed circuit board, or, alternatively, any type of material layer that permits conductive elements to be included on or in the material. Although a rectangular shaped first signal trace layer 780 is shown in FIG. 7C, the geometry or shape of the first signal trace layer 780 may be of any desired shape or configuration.

The second signal trace layer 790 shown on FIG. 7D operates to route signals along second layer signal traces (791, 792, 793, 794) located on the second signal trace layer 790 of the touch sensing device. For example, when a user manipulates the input key 751, a signal is transmitted along the first signal trace 791 due to the user's finger cooperating with a second of the two electrodes (e.g. electrode 768) of the input key 751. When a user manipulates the input key 755, a signal is transmitted along the second signal trace 792 due to the user's finger cooperating with a second of the two electrodes of the input key 755. When a user manipulates the input key 759, a signal is transmitted along the third signal trace 793 due to the user's finger cooperating with a second of the two electrodes of the input key 759. When a user manipulates the input key 763, a signal is transmitted along the fourth signal trace 794 due to the user's finger cooperating with a second of the two electrodes of the input key 763. The second layer signal traces (791, 792, 793, 794) electrically connect with output signal traces (775, 776, 777, 778) of the electrode layer 750 through conductive vias that extend between the layers. Similar to the discussion above for the electrode layer 750, a ground mesh 795 is incorporated on the remaining surface area of the second signal trace layer 790 and is isolated from the second layer signal traces (791, 792, 793, 794) to help in isolating signal traces in adjacent layers. In an alternative embodiment, no ground mesh may be needed. The second signal trace layer 790 may be a printed circuit board, or, alternatively, any type of material layer that permits conductive elements to be included on or in the material. Although a rectangular shaped second signal trace layer 790 is shown in FIG. 7D, the geometry or shape of the second signal trace layer 790 may be of any desired shape or configuration.

Thus, when a user touches the key representation 701 on the overlay layer 700, the user cooperates with both the first and second electrodes (767, 768) of the input key 751 on the electrode layer 750. The first electrode 767 is connected with the signal trace 781 on the first signal trace layer 780 and the second electrode 768 is connected with the signal trace 791 on the second signal trace layer 790. The signal traces may be copper traces or, alternatively, any other conductive material capable of transmitting a signal thereon. Due to the connection of the signal trace 781 with the output signal trace 771 and the signal trace 791 with the output signal trace 775, a processor or other controller connected to the output signal traces (771, 775) would recognize a transmitted signal or a change in a signal for output signal traces 771 and 775, representing a user touch of the input key 751. An additional ground layer having a ground mesh may be coupled or positioned beneath or adjacent to the second signal trace layer 790 such that a user's touch or other electrical interference with the bottom of the touch sensing device will not create signal disturbances on signal trace layers above.

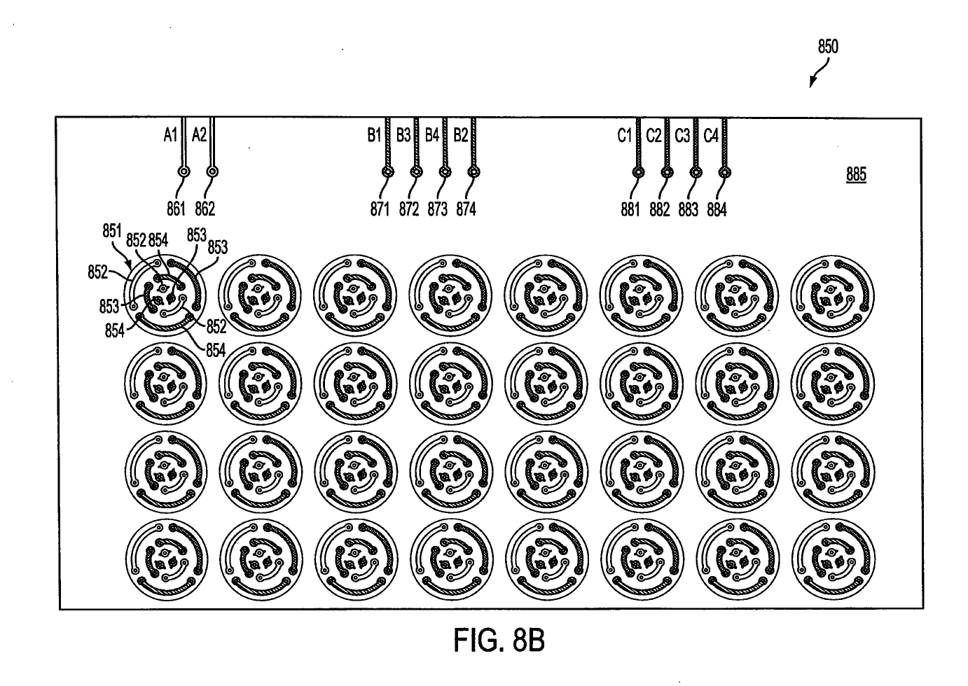

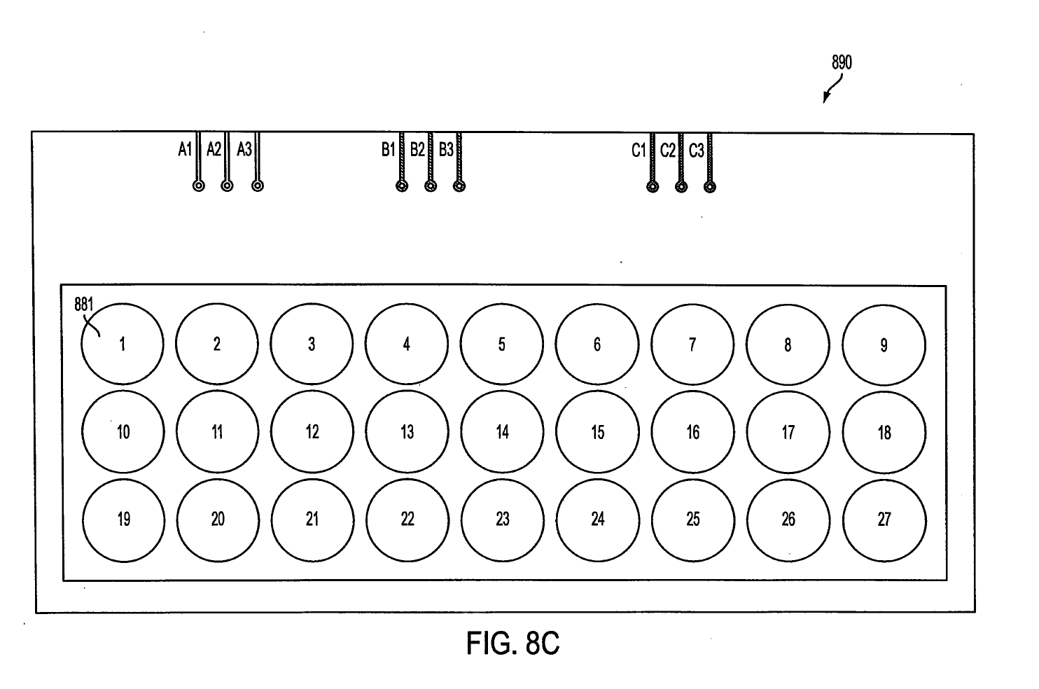

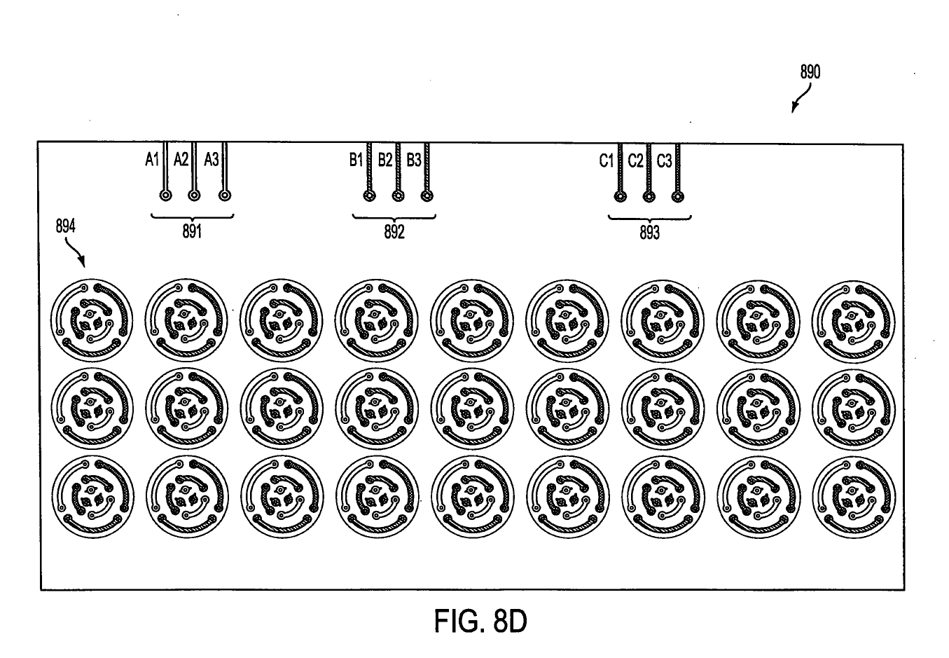

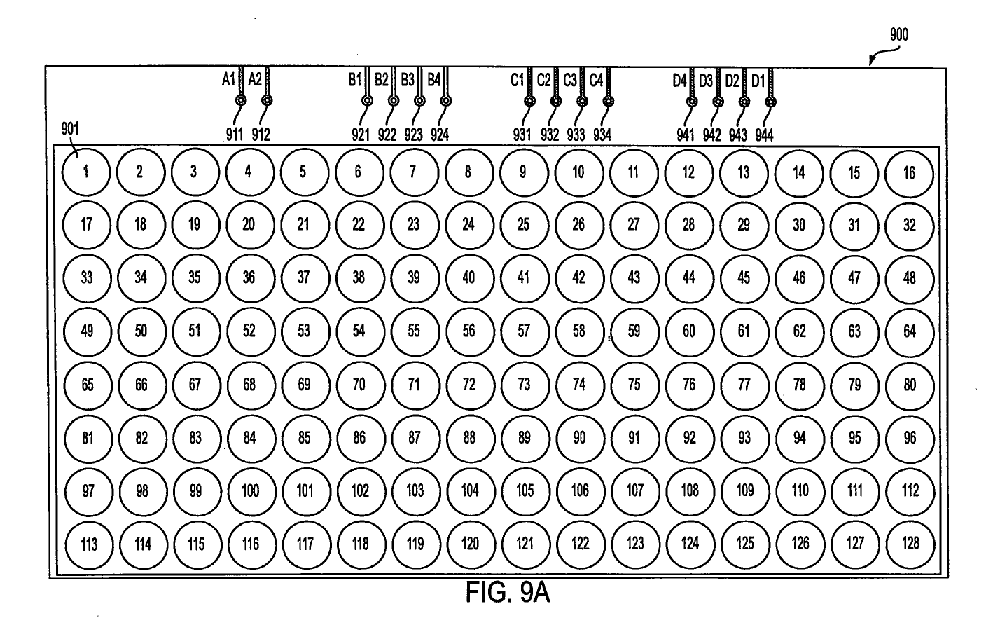

In another embodiment, a touch sensing input device may have a dimensionality of three, thus having three signal trace layers, and is discussed for FIGS. 8A and 8B. Generally, the three dimension touch sensing input device may have certain structural and functional features that are the same or similar to those of the two dimension touch sensing input device discussed for FIGS. 7A-7D. Notwithstanding these similar features, the three dimension touch sensing input device may be distinguished from the two dimension touch sensing input device based primarily on the number of signal trace layers and the number of electrodes per input key, as discussed in greater detail herein.

FIG. 8A shows a top view of a grid overlay layer 800 for a three dimension touch sensing input device. A corresponding electrode layer 850 is shown in FIG. 8B, as discussed in greater detail herein. For three dimension functionality, the touch sensing device would thus have a first signal trace layer, a second signal trace layer, and a third signal trace layer for the routing of signals to an output connector or other device, as discussed in greater detail herein.

Looking first to the grid overlay layer 800 of FIG. 8A, a plurality of thirty two key representations (e.g., the key representation 801) are printed or otherwise disposed upon the grid overlay layer 800. These key representations may be similar to the key representations (701, 702, 703, 704, 705, 706, 707, 708, 709, 710, 711, 712, 713, 714, 715, 716) discussed above for FIG. 7A. The associated output signal line representations (821, 822, 831, 832, 833, 834, 841, 842, 843, 844) are also printed or otherwise disposed upon the grid overlay layer 800. A user of the touch sensing device incorporating the grid overlay layer 800 would thus expect to be able to interact with thirty two different inputs located at the positions of the printed key representations (e.g., the key representation 801).

Looking next to the electrode layer 850 of FIG. 8B, a plurality of thirty two input keys (e.g., the input key 851) are positioned substantially beneath the thirty two key representations (e.g., the key representation 801) of the grid overlay layer 800. Each of the thirty two input keys has three associated electrodes (852, 853, 854) for three dimension touch sensing functionality. The first electrode 852 electrically connects with signal traces on a first signal trace layer (not shown). The first electrode 852 may be formed either as one conductive surface on the electrode layer 850 or may be formed as a plurality of smaller conductive surfaces that are electrically connected together, for example, on the first signal trace layer. The second electrode 853 electrically connects with signal traces on a second signal trace layer (not shown). The second electrode 853 may be formed either as one conductive surface on the electrode layer 850 or may be formed as a plurality of smaller conductive surfaces that are electrically connected together, for example, on the second signal trace layer. The third electrode 854 electrically connects with signal traces on a third signal trace layer (not shown). The third electrode 854 may be formed either as one conductive surface on the electrode layer 850 or may be formed as a plurality of smaller conductive surfaces that are electrically connected together, for example, on the third signal trace layer.

Thus, when a user places their finger on the key representation 801 on the grid overlay layer 800, electrical contact is also made with all three of the associated electrodes (852, 853, 854) of the input key 851. The electrodes (852, 853, 854) may be made of any conductive material, such as copper. The configuration of the electrodes (852, 853, 854) for a given three dimensional input key (e.g., the input key 851) may be the same or similar to, for example, any of the input keys 430 shown for FIG. 4C and selected so as to provide a desired balance between touch sensitivity and manufacturing cost.

The electrode layer 850 also includes the output signal traces (861, 862, 871, 872, 873, 874, 881, 882, 883, 884) for transmitting one or more signals along signal traces in or on signal trace layers (not shown) to a processor or other controller, the same or similar to the discussion above for FIG. 7B. Because of the three dimensionality of the touch sensing device, a connected processor would only require ten input pins to accommodate the output signal traces (861, 862, 871, 872, 873, 874, 881, 882, 883, 884) for the thirty two input keys. Three signal trace layers (not shown) are coupled or positioned adjacent to or beneath the electrode layer 850 for the routing of signals to the output signal traces (861, 862, 871, 872, 873, 874, 881, 882, 883, 884), in a similar manner to the signal trace layers (780, 790) discussed above for FIGS. 7C-7D. Furthermore, a ground mesh 885 may be disposed on a surface of the electrode layer 850 and/or on other layers, the same or similar to the discussion above for FIGS. 7B-7D. While the key representations (e.g., the key representation 801) and input keys (e.g., the input key 851) described for FIGS. 8A and 8B utilize a circle or round model for sensitivity purposes with a dimensionality of three, any of a variety of key representations or input key configurations (e.g. square, circle, triangle, pentagon, hexagon, etc) or dimensionality may be used in an alternative embodiment.

Similar to the discussion above for FIGS. 8A and 8B, a touch sensing input device may have a dimensionality of three and utilize twenty seven input keys, as is discussed for FIGS. 8C and 8D. Generally, the three dimension touch tensing input device with twenty seven keys may have certain structural and functional features that are the same or similar to those previously described for the three dimension touch sensing input device of FIGS. 8A and 8B. Notwithstanding these similar features, the three dimension touch sensing input device with twenty seven input keys may be distinguished from the three dimension touch sensing input device of FIGS. 8A and 8B based primarily on the fewer number of input keys and the alternative arrangement of signal traces, as discussed herein.

FIG. 8C shows a top view of a grid overlay layer 880 for a three dimension touch sensing input device and having twenty seven key representations (e.g., the key representation 881) instead of the thirty two key representations shown for FIGS. 8A and 8B. A corresponding electrode layer 890 is shown in FIG. 8D. As previously discussed for FIGS. 8A and 8B, a three dimension touch sensing device utilizes three signal trace layers, similar to the discussion above for FIGS. 7A-7D for the routing of signals to an output connector or other device. A first signal trace layer (not shown) is used for routing a first set 891 of output signals (A1, A2, A3), a second signal trace layer (not shown) is used for routing a second set 892 of output signals (B1, B2, B3) and a third signal trace layer (not shown) is used for routing a third set 893 of output signals (C1, C2, C3). Thus, nine total output signals (A1, A2, A3, B1, B2, B3, C1, C2, C3) are used (i.e. 3×3×3 signal lines) for determining the user interactions with the twenty seven input keys (e.g., the input key 894). The electrode layer 890 is positioned substantially beneath the grid overlay layer 880 such that a user touching or otherwise manipulating a key representation (e.g., the key representation 881) on the grid overlay layer 880 will interact with a corresponding input key (e.g., the input key 894) on the electrode layer 890, the same or similar to the previously described embodiments. Certain aspects of the grid overlay layer 880 and/or the electrode layer 890 may be the same or similar to those previously discussed.

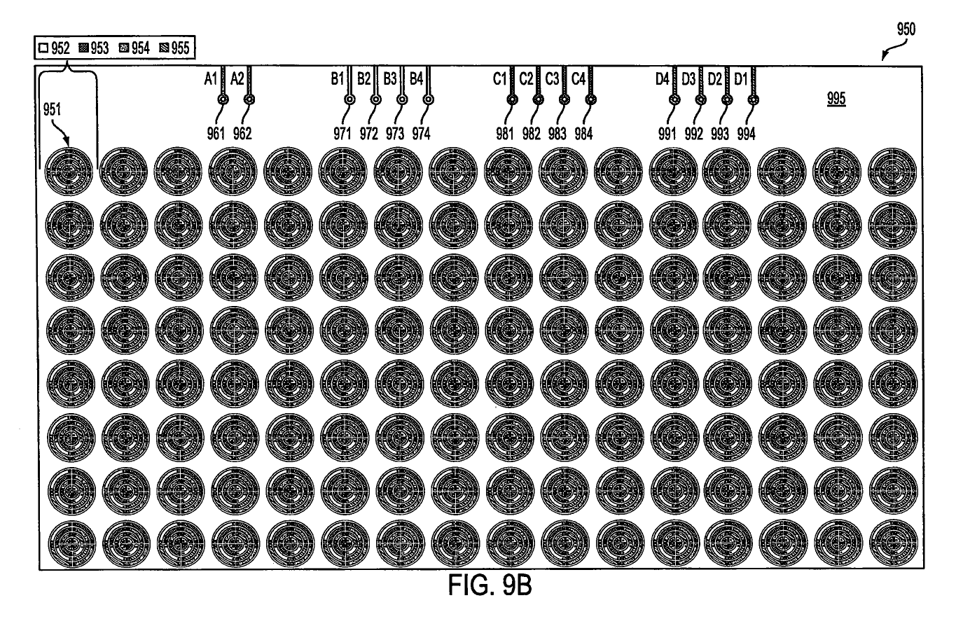

In yet another embodiment, a touch sensing input device may have a dimensionality of four, thus having four signal trace layers, and is discussed for FIGS. 9A and 9B. Generally, the four dimension touch sensing input device may have certain structural and functional features that are the same or similar to those of the two dimension touch sensing input device of FIGS. 7A-7D and/or the three dimension touch sensing input device of FIGS. 8A-8D. Notwithstanding these similar features, the four dimension touch sensing input device may be distinguished from the two dimension touch sensing input device and/or the three dimension touch sensing input device based primarily on the number of signal trace layers and the number of electrodes per input key, as discussed in greater detail herein.

FIG. 9A shows a top view of a grid overlay layer 900 for a four dimension touch sensing input device having one hundred and twenty eight input keys and using fourteen signal lines in a 2×4×4×4 configuration. A typical mechanical computer 101 keyboard may thus be replaced with such a touch sensing input device, eliminating or reducing drawbacks associated with mechanical keyboards (e.g. dust or water interfering with keyboard operation, lower manufacturing cost, etc). A corresponding electrode layer 950 is shown in FIG. 9B, as discussed in greater detail herein. Such a touch sensing input device would have a first signal trace layer (not shown), a second signal trace layer (not shown), a third signal trace layer (not shown), and a fourth signal trace layer (not shown) for the routing of signals to an output connector or other device, as discussed in greater detail herein.

Looking first to the grid overlay layer 900 of FIG. 9A, a plurality of one hundred and twenty eight key representations (e.g., the key representation 901) are printed or otherwise disposed upon the grid overlay layer 900. These key representations may be similar to the key representations discussed above for FIG. 7A, FIG. 8A or FIG. 8C. The associated output signal line representations (911, 912, 921, 922, 923, 924, 931, 932, 933, 934, 941, 942, 943, 944) are also printed or otherwise disposed upon the grid overlay layer 900. A user of the touch sensing device incorporating the grid overlay layer 900 would thus expect to interact with one hundred twenty eight different inputs located at the positions of the printed key representations (e.g., the key representation 901).

Looking next to the electrode layer 950 of FIG. 9B, a plurality of one hundred twenty eight input keys (e.g., the input key 951) are positioned substantially beneath the one hundred twenty eight key representations (e.g., the key representation 901) of the grid overlay layer 900. Each of the one hundred twenty eight input keys (e.g., the input key 951) has four associated electrodes (952, 953, 954, 955) for four dimensional touch sensing functionality. The first electrode 952 electrically connects with signal traces on a first signal trace layer (not shown). The first electrode 952 may be formed either as one conductive surface on the electrode layer 950 or may be formed as a plurality of smaller conductive surfaces that are electrically connected together, for example, on the first signal trace layer. The second electrode 953 electrically connects with signal traces on a second signal trace layer (not shown). The second electrode 953 may be formed either as one conductive surface on the electrode layer 950 or may be formed as a plurality of smaller conductive surfaces that are electrically connected together, for example, on the second signal trace layer. The third electrode 954 electrically connects with signal traces on a third signal trace layer (not shown). The third electrode 954 may be formed either as one conductive surface on the electrode layer 950 or may be formed as a plurality of smaller conductive surfaces that are electrically connected together, for example, on the third signal trace layer. The fourth electrode 955 electrically connects with signal traces on a fourth signal trace layer (not shown). The fourth electrode 955 may be formed either as one conductive surface on the electrode layer 950 or may be formed as a plurality of smaller conductive surfaces that are electrically connected together, for example, on the fourth signal trace layer.

Thus, when a user places their finger on the key representation 901 on the grid overlay layer 900, electrical contact is also made with all four of the associated electrodes (952, 953, 954, 955) of the input key 951. The electrodes may be made of any conductive material, such as copper. The configuration of the electrodes for a given four dimensional input key may be the same or similar to, for example, any of the input keys 440 shown for FIG. 4D and selected so as to provide a desired balance between touch sensitivity and manufacturing cost.

The electrode layer 950 also includes the output signal traces (961, 962, 971, 972, 973, 974, 981, 982, 983, 984, 991, 992, 993, 994) for transmitting one or more signals along signal traces in or on the signal trace layers to a processor or other controller, the same or similar to the discussion above for FIG. 7B, FIG. 8B or FIG. 8D. Because of the four dimensionality of the touch sensing device, a connected processor would only require fourteen input pins to accommodate the output signal traces (961, 962, 971, 972, 973, 974, 981, 982, 983, 984, 991, 992, 993, 994) for the one hundred twenty eight input keys. Four signal trace layers (not shown) are coupled or positioned adjacent to or beneath the electrode layer 950 for the routing of signals to the output signal traces (961, 962, 971, 972, 973, 974, 981, 982, 983, 984, 991, 992, 993, 994), in a similar manner to the signal trace layers discussed above for FIGS. 7C-7D. Furthermore, a ground mesh 995 may be disposed on a surface of the electrode layer 950 and/or on other layers at locations where there are no electrodes or signal traces, the same or similar to the ground meshes discussed above for FIGS. 7B-7D. While the key representations (e.g., the key representation 901) and the input keys (e.g., the input key 951) described utilize a circle or round model for sensitivity purposes with a dimensionality of four, any of a variety of key representations or input key configurations (e.g., square, circle, triangle, pentagon, hexagon, etc.) or dimensionality may be used in an alternative embodiment.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A multiple layer touch sensing device comprising:
a first layer;
a touch key disposed on the first layer, the touch key having a first electrode and a second electrode;
a second layer coupled to the first layer;
a first trace disposed on the second layer and electrically connected to the first electrode of the touch key;
a third layer coupled to the second layer; and
a second trace disposed on the third layer and electrically connected to the second electrode of the touch key.

2. The multiple layer touch sensing device of claim 1 further comprising a protective layer coupled to the first layer for preventing damage to the touch key.

3. The multiple layer touch sensing device of claim 2 further comprising a fourth layer coupled to the protective layer and having an overlay corresponding with the first touch key.

4. The multiple layer touch sensing device of claim 3 further comprising a ground layer coupled to the third layer and having a ground mesh.

5. The multiple layer touch sensing device of claim 1 wherein the first layer includes a first ground mesh, the touch key electrically isolated from the ground mesh.

6. The multiple layer touch sensing device of claim 5 wherein the second layer or the third layer includes a second ground mesh, the first trace of the second layer or the second trace of the third layer being electrically isolated from the second ground mesh.

7. The multiple layer touch sensing device of claim 1 wherein both the first electrode and the second electrode are positioned so as to be electrically connected with a user when the user cooperates with the touch key.

8. The multiple layer touch sensing device of claim 1 further comprising an output connector having a first conductor and a second conductor, the first conductor electrically connected with the first trace and the second conductor electrically connected with the second trace.

9. A multiple layer touch sensing input apparatus comprising:
an electrode layer having a first ground mesh;
a first touch input located on the electrode layer and isolated from the first ground mesh, the first touch input having a first electrode, a second electrode and a third electrode;
a first layer positioned adjacent to the electrode layer and having a second ground mesh;
a first trace located on the first layer and isolated from the second ground mesh, the first trace connected to the first electrode of the first touch input;
a second layer positioned adjacent to the first layer and having a third ground mesh;
a second trace located on the second layer and isolated from the third ground mesh, the second trace connected to the second electrode of the first touch input;
a third layer positioned adjacent to the second layer and having a fourth ground mesh; and
a third trace located on the third layer and isolated from the fourth ground mesh, the third trace connected to the third electrode of the first touch input.

10. The multiple layer touch sensing input apparatus of claim 9 further comprising a ground layer positioned adjacent to the third layer and having a fifth ground mesh.

11. The multiple layer touch sensing input apparatus of claim 9 wherein the second electrode and the third electrode are positioned so as to be cooperate with a user when the user cooperates with the first electrode of the first touch input.

12. The multiple layer touch sensing input apparatus of claim 11 wherein the first touch input substantially forms a shape selected from the group consisting of a square, a circle, a triangle, a pentagon and a hexagon.

13. The multiple layer touch sensing input apparatus of claim 9 further comprising an output connector having a first output conductor, a second output conductor and a third output conductor, the first output conductor connected to the first trace, the second output conductor connected to the second trace and the third output conductor connected to the third trace.

14. The multiple layer touch sensing input apparatus of claim 9 further comprising a second touch input located on the electrode layer and isolated from the first ground mesh, the second touch input having a fourth electrode, a fifth electrode and a sixth electrode.

15. The multiple layer touch sensing input apparatus of claim 14 wherein the fourth electrode of the second touch input is connected to any of the first trace, the second trace, or the third trace.

16. A method for reducing a number of signals output from a touch sensing device, the method comprising the steps of:
providing an electrode layer having a plurality of touch keys;
providing a first layer having a first trace connected to a first portion of a first one of the plurality of touch keys and a second trace connected to a first portion of a second one of the plurality of touch keys;
providing a second layer having a third trace connected to a second portion of the first one of the plurality of touch keys and a fourth trace connected to a second portion of the second one of the plurality of touch keys;
allowing the transfer of a first signal along the first trace and a third signal along the third trace when a user cooperates with the first one of the plurality of touch keys; and
allowing the transfer of a second signal along the second trace and a fourth signal along the fourth trace when a user cooperates with the second one of the plurality of touch keys.

17. The method of claim 16 further comprising the step of connecting each of the first trace, the second trace, the third trace and the fourth trace to a connector.

18. The method of claim 16 further comprising the step of connecting each of the first trace, the second trace, the third trace and the fourth trace to a processor.

19. The method of claim 16 further comprising the step of preventing the first signal from transferring along the first trace, the second signal from transferring along the second trace, the third signal from transferring along the third trace and the fourth signal from transferring along the fourth trace when a user is not cooperating with any of the plurality of touch keys.

20. The method of claim 19 further comprising the step of providing a ground layer having a ground mesh for the preventing of the first signal from transferring along the first trace, the second signal from transferring along the second trace, the third signal from transferring along the third trace and the fourth signal from transferring along the fourth trace when a user is not cooperating with any of the plurality of touch keys.
